(19) United States
(12) Patent Application Publication
(10) Pub. No.: US 2026/0307755 A1
(43) Pub. Date: Oct. 8, 2026

(54) STRUCTURAL COMPONENT OF A BICYCLE, BICYCLE FRAME, BICYCLE COMPRISING A STRUCTURAL COMPONENT, AND HANDLEBAR AS A STRUCTURAL COMPONENT

(71) Applicant: IGUS GMBH, Köln (DE)

(72) Inventor: Frank BLASE, Bergisch Gladbach (DE)

(21) Appl. No.: 19/478,887

(22) PCT Filed: Apr. 24, 2024
(86) PCT No.: PCT/EP2024/061292

§ 371 Date: Oct. 27, 2025

(30) Foreign Application Priority Data
Apr. 27, 2023 (DE) 20 2023 102 312.6

(51) Int. Cl. B62K 19/16; B62K 3/02; B62K 19/22; B62K 21/12

(52) U.S. Cl. CPC B62K 19/16; B62K 3/02; B62K 21/12; B62K 19/22

(57) ABSTRACT

A structural component of a bicycle, comprising a core with at least one cavity and an encasing lateral surface, and comprising a shell element with the stipulation that both the core and the shell element each have a structurally supporting function, and that the supporting function is reinforced by means of an integrally joined connection between the encasing lateral surface of the supporting core and an inner surface of the supporting shell element; and a bicycle frame comprising a plurality of frame components, of which at least one is formed as a structural component; and a bicycle comprising at least one component which is formed as a structural component, and a handlebar which is formed as a structural component.

### FIELD

The invention relates to a structural component of a bicycle, wherein for the purposes of the invention a structural component is understood in particular to mean safety-relevant bicycle structural components, these being more narrowly bicycle structural components such as bicycle frame, fork or steering knuckle, stem, handlebar, seatpost, crank arms and pedals which are of relevance to the safety of the bicycle when it is being ridden. Other elements that are understood to be bicycle structural components, however, are those such as frame components which can be fitted together to form a bicycle frame. More broadly, elements such as wheel rims or wheels are also included. Furthermore, structural components according to the invention may also encompass accessories such as, for example seat, brake and gear levers, fender or splash guard, bicycle support (stand), luggage carrier, luggage holder, child seat, etc.

The proposed structural component of a bicycle encompasses a bicycle structural component or one intended for a bicycle and will hereinafter be designated more simply as “structural component”.

The structural component comprises a core having at least one internal cavity and an encasing circumferential surface and comprises a shell element.

Furthermore, the invention relates to a bicycle frame comprising at least one of the above-mentioned frame components configured as the structural component according to the invention.

Moreover, the invention relates to a bicycle comprising at least one element configured as the structural component according to the invention.

Moreover, the invention relates to a handlebar configured as the structural component according to the invention.

### BACKGROUND

Publication DE 195 81 569 T1, which proposes a plurality of bicycle frame embodiments, is known in the relevant technical field. One example proposes a bicycle frame having a core of injection-molded plastics material. Outwardly directed outer ribs are arranged on the injection-molded core. Sheathing is provided around the outer ribs but this is preferably not intended to be needed for structural purposes because this task is performed by the core with the outer ribs. The sheathing is, for example, a shrink film of plastics, which is mounted around the core and heated such that it rests close against the core. The structural strength is provided, in this example, by the core with its outer ribs.

Another example from the same publication reverses the principle of the above example and proposes instead an internal bladder which serves to produce the walls of the bicycle frame by way of a mold. The internal bladder is inserted into the mold as a core and can be filled with a liquid or another material so as to be able to withstand the pressure on injection of the thermoplastic material from which the bicycle frame is formed. Alternatively, the bladder may be constructed with a rib structure for withstanding the prevailing pressure, or lower pressures may be used. The walls of the bicycle frame are produced between the outer mold and the internal bladder, with the space between the bladder and the outer mold corresponding to the thickness of the walls of the finished bicycle frame.

The prior art with internal bladder is unsatisfactory in terms of the strength of the structure. This is likewise the case for the exemplary embodiment of the bicycle frame having a core with external ribs.

### SUMMARY

The invention proposes a structural component for a bicycle comprising a core having at least one cavity and one encasing circumferential surface, and comprising a shell element, with the proviso that both the core and the shell element in each case have a structurally supporting function, and the supporting function is reinforced by way of a material bond between the encasing circumferential surface of the supporting core and an inner surface of the supporting shell element. The cavity of the core is preferably a geometrically defined cavity.

The material bond may be provided by fusing the material of the shell element with the material of the core. This fusion takes place between the circumferential surface of the core and the starting material of the shell element. The materials involved are in a state in which they are at least partly molten. For the material bond, an additional material which is capable of fusing together with the materials involved may moreover be added. Identical starting materials may advantageously be used for the core elements and/or for the shell element. If used, the additional material for the material bond may be produced from the same starting material as the core elements and/or the shell element. Alternatively, a material bond may be produced using an adhesive additional material which is arranged between the encasing circumferential surface of the core and the inner surface of the supporting shell element.

As in the prior art, the proposed structural component may be embodied for example as a bicycle frame, wherein the structural component according to the invention exhibits improved strength. On the one hand, the effect of the shell element is not only to improve aerodynamics and appearance but also to contribute, as a supporting shell element, to inherent structural strength. The structural strength thereof is enhanced by the likewise inherent structural strength of the supporting core. Furthermore, the strength of the structural component overall is improved still further by way of the material bond connecting the supporting core to the supporting shell element. In the embodiment of the structural component as a bicycle frame, the shell element preferably makes a major contribution to the strength and rigidity of the bicycle frame. Particularly preferably, the shell element is designed such that its contribution to the strength and rigidity of the bicycle frame is at least as significant as the contribution of the core.

According to the invention, the encasing circumferential surface of the supporting core is a substantially smooth surface. It may be configured as a freely shaped surface, e.g., similar to a curved vehicle body, or for example form a simple cylindrical circumferential surface. The circumferential surface may also be assembled from portions, for example portions of cylindrical, prismatic or conical basic shapes. A surface with external ribs is not considered to be a substantially smooth circumferential surface for the purposes of the invention. The shape of the encasing circumferential surface is, moreover, conveniently adapted to the outer contour of the shell element. A uniform thickness for the wall thickness of the shell element is advantageously provided between the outer contour of the shell element and the circumferential surface of the core. The wall thickness of the shell element may vary somewhat in places, in order to provide regions of greater strength and rigidity. A gentle, continuous transition is advantageously provided between areas of lesser and greater wall thickness to prevent a notch effect.

Conveniently, either the core and/or the shell element is produced using a starting material which is flowable in a plastic state within the mold cavity of a shaping mold. In one preferred embodiment, the shell element may, for example, be produced using a shaping injection mold. To this end, the core is advantageously placed inside the injection mold. The mold cavity of the injection mold forms the negative of the outer contour of the shell element. The core, which remains therein, forms the inner contour of the shell element. At the same time, the injection molding process produces the material bond by the surface of the injected starting material of the shell element fusing onto the material of the circumferential surface of the core and the materials of shell element and core bonding together in this way. The core is sufficiently stable to provide a sufficiently strong wall underneath the fused circumferential surface thereof to withstand the injection pressure during injection molding of the starting material of the shell element.

The injection mold is conveniently equipped with at least one stationary mold part and at least one movable mold part. When closed, the mold parts meet at a parting line. The injection mold may be opened and closed at the parting line and filled repeatedly with starting material, such that a finished molded workpiece can be removed after each shaping process.

The structural strength and rigidity of the supporting shell element benefits if the starting material thereof can be injected with a high injection pressure into the mold cavity. To this end, the core is preferably specially produced to be able itself to withstand a high injection pressure from the flowable starting material for the shell element without collapsing.

For this purpose, the circumferential surface of the core is preferably embodied with a wall thickness which can withstand the high injection pressure sufficiently well to ensure that no hole arises through which starting material could penetrate into the cavity of the core.

The supporting shell element makes a major contribution to the structural strength of the structural component. The contribution it makes in terms of strength can be influenced by the selection and quality of the starting material and by the shell thickness of the shell element. Moreover, the core, having an inherent structural strength, also makes a contribution. The structural strength of the structural component is further reinforced overall by the material bond firmly joining the supporting core to the supporting shell element.

The quality of the structural component, in terms of strength and rigidity, is based on the shell element combined with the core and the bond therebetween. The quality of the core and of the material bond is concealed under or within the shell element. Non-destructive investigation thereof can be performed using an imaging materials testing method, for example using computed tomography.

The starting material for the core and/or the shell element is preferably a thermoplastic plastics material. The plastics material may be a single-grade plastics material or a compound comprising a base plastics material mixed with at least one other plastics material. Furthermore, the single-grade plastics material or the compound can be provided with at least one filler, for example a filler of reinforcing fibers and/or other reinforcing particles.

The core may be of one-piece configuration or assembled from a plurality of core elements. Because the core has at least one cavity, production using 3D printing and a starting material suitable for the purpose is, for example, appropriate for one-piece construction. For other starting materials, a lost-wax molding method is, for example, suitable for producing a one-piece core. For this purpose, a lost wax mold can be simply produced which has the identical shape to the core, and which melts away on molding the starting material.

The above production methods are likewise applicable to a core assembled from a plurality of core elements, as are further manufacturing methods. Individual core elements may be produced, for example, using a starting material which is processable in a flowable plastic state within the mold cavity of a shaping mold, for example by injection molding. This is preferably carried out using an injection mold having at least one stationary and one movable mold part, these being openable and closable at a parting line in order to be able to carry out repeated injection molding cycles.

The core according to the invention may have a complex shape. Its shape may be provided with undercuts relative to the shell element, these making it impossible to use a reusable core provided in the mold.

Each core element advantageously has an outer surface and edges. The outer surfaces of a plurality of core elements form the circumferential surface of the core when assembled. Edges of the core elements adjoin one another when fitted together.

At least one parting joint is formed at the edges of the outer surfaces of assembled core elements, wherein a sealing means is preferably provided for the parting joint. If, in particular, the shell element is produced in a shaping mold and the core is placed in the mold cavity, the effective seal helps in preventing flowable plastic starting material of the shell element from penetrating into the parting joints of the core, or as far as into the cavity thereof.

A materially bonding additional substance, e.g., an adhesive, can be simply provided as a sealing means, or said sealing means may advantageously take the form of mechanically interacting sealing edges at the edges of the core elements. Such sealing edges are preferably of complementary configuration, for example as rabbeted edges or edges with tongue and groove elements.

The core, or at least one of the core elements, is advantageously provided with at least one internal stiffening element.

This measure reinforces the core. The reinforced core promotes production of the shell element therearound, in particular if the shell element is to be produced by injection molding. To this end, the core is inserted into an injection mold to shape the shell element and a central constituent part of the structural component, concealed however within the shell element, remains as a structurally supporting core.

The internal stiffening element simply takes the form of a strut or rib.

A strut or rib may advantageously be so configured that the core element may in turn be produced in a mold cavity of a shaping mold, for example by injection molding. Core elements may conveniently be produced in an injection mold in cycles.

The positive effect in terms of the stability of the structural component may be reinforced if struts or ribs of core elements assembled to form a core support one another.

For a shell element which is produced by injection molding, it is advantageous for a core to be provided which is sufficiently stable to be able to withstand a high injection pressure of the starting material of the shell element when the latter is injected into the mold cavity in order to give the shell element the desired shape. A high injection pressure promotes the flowability of the starting material in its plastic state, i.e., in the molten flowable state. The injection pressure advantageously influences the viscosity of the starting material in such a way that viscosity increases. The high viscosity means thin-walled regions of a mold cavity can be better filled. This means struts or ribs can be optimized. They may be as thin-walled as possible, in order to minimize material use while nonetheless providing good support for the core when a high injection pressure acts externally on the circumferential surface thereof. In this way, economies of material volume can be achieved and the structural component can be sufficiently stable but nonetheless light.

It is moreover useful for the core to have at least one protruding position element on its circumferential surface, and for the position element to be provided to fix the core in place inside a mold cavity of a shaping mold for production of the supporting shell element in said mold cavity.

The core or core element is advantageously provided with a sufficient number of protruding position elements. These are arranged distributed over the circumferential surface and hold the core in its desired shape and position, for example if the shell element is injection molded. The molten flowable starting material thereof may exert uneven forces in places on the core within the mold cavity, said core being deformed by exposure to these forces and possibly moving from its desired position within the mold cavity. The protruding position elements advantageously counteract a change in shape of the core or departure from its desired position within the mold cavity.

The position element conveniently forms a distance which produces contact with the inside of the mold cavity, so simply enabling the exact desired positioning relative to the shaping mold. Furthermore, the position elements have a favorable effect on the shape of the core. The latter retains its shape due to being fixed in place, despite high pressure forces acting externally on the core.

The position elements on the circumferential surface of the core or of the core elements moreover contribute an interlocking element for connection with the shell element. By protruding into the finished shell element, the position element results in an undercut. The undercut contributes an interlocking element to the connection which assists with the material bond between the supporting core and the supporting shell element.

Alternatively, position elements on the circumferential surface of the core can be dispensed with if, instead, at least one mold-side position element is arranged in the shaping injection mold. Advantageously, the mold-side position element is arranged in the mold cavity and conveniently incorporated into the inside of the mold cavity. When the injection mold is in the closed state, the mold-side position element projects from the inside of the mold cavity and comes into contact with the circumferential surface of the core, so as to hold the latter in shape and at its intended position within the mold cavity.

It is, moreover, also possible to produce a structural component according to the invention without position elements protruding from the circumferential surface of the core and also without mold-side position elements protruding from the inside of the mold cavity toward the core, if the core has a suitable retaining portion away from its circumferential surface and the injection mold has matching means for fixing the position of the core within the closed mold cavity.

In one embodiment, the supporting shell element may form the shape of a bicycle frame comprising a front end contour with head tube portion, a bottom contour with bottom bracket portion, a top contour with seat tube portion and a back end contour with back axle portion for a back wheel axle.

In this embodiment, the shell element of the structural component is preferably in one piece when viewed externally. As second supporting component in the interior thereof, however, it contains the core, which is advantageously fitted together from a plurality of core elements. In terms of a bicycle frame, this structural component is so configured as to meet the requirements for bicycles as standardized in DIN EN ISO 4210:2015.

The invention further proposes a bicycle frame comprising a plurality of frame components, some of which are configured as node elements and some as frame elements, wherein the node elements and frame elements are connected together, with the proviso that at least one of the node elements and/or one of the frame elements is configured as a structural component according to the invention.

The frame component, as a structural component, is advantageously configured such that it satisfies the safety requirements within the finished bicycle frame standardized for bicycles in DIN EN ISO 4210:2015. This is true in particular of all the frame components of the bicycle frame which are configured as structural components according to the invention. Other frame components which are not structural components for the purposes of the invention optionally also meet these requirements. These requirements are, moreover, met by the bicycle frame as a whole.

If the bicycle frame can be assembled from multiple frame components, this results in a high level of variability when it comes to adapting it to a person's individual physique, for example. For instance, the bicycle frame may be adapted to the individual's body measurements, such as the length of their arms, legs or back. Moreover, the desired posture of the person when seated on the bicycle may be taken into account, such as seat height, sitting posture, inclination of back etc., to provide a bicycle frame matching these features.

Alternatively, frame components in the form of structural components according to the invention may be provided as a modular system, for example as modules of graduated size.

A material bond is conveniently provided to connect the node element(s) to the frame element(s).

The material bond is simply provided using an additional material. The additional material may, for example, be a one-component adhesive or a two-component adhesive. Alternatively, the additional material may be a castable material which can be processed in a shaping mold, for example a flowable material which can be injection molded in the same way as an injection molding starting material for the shell element.

At least one node element is preferably provided with a fusion region, wherein at least one frame element is provided with a connection region which interacts with the fusion region of the node element. It is beneficial for the fusion region and the connection region to define the mutually relative position of the node element and the frame element when fitted together.

The additional bonding material, or adhesive, is simply arranged between the fusion region of the node element and the connection region of the frame element. The fusion region and the connection region then constitute bonding surfaces between which a narrow gap for adhesive is preferably formed.

Finally, a bicycle is proposed which comprises at least one element from the group including bicycle frame, fork, stem, handlebar, seatpost, crank arms, wherein at least one of the stated elements is configured as a structural component according to the invention.

A handlebar for a bicycle is also proposed which takes the form of a structural component according to the invention.

The proposed handlebar exhibits excellent safety and can be heavily loaded while being ridden. Heavy loading arises, in principle, during acceleration and braking. Acceleration causes alternating loads, if alternating left-and rightward loads are applied to the handlebar grips. During braking, the two handlebar grips may be exposed to more even loading. Handlebar failure can lead to injury. The handlebar is therefore one of a bicycle's safety-relevant elements. For safety reasons, a used handlebar should be replaced by a new handlebar after a given service life, even if the used handlebar does not exhibit any obvious damage. The safety of the proposed handlebar is based on a supporting core and a supporting shell element, which in each case provide inherent structural strength and rigidity, and on the fact that the strength and rigidity thereof is further reinforced by way of the material bond provided between core and shell element.

A core is advantageously provided which is assembled from at least two core elements, and by the core elements being injection molded from a thermoplastic plastics material.

Further benefit is provided if a retaining portion is arranged at each of the free ends of the core elements and said retaining portion is provided to fix the core element in place in an injection mold. Fixing the core element or the assembled core precisely in place promotes the production of a precise shell element, whose defined shell wall contributes to the desired strength and rigidity.

The retaining portions of the core elements are preferably of complementary configuration, wherein each core element has a means for positioning it correctly in contact with the complementary core element.

It has also proven convenient for the retaining portions of the core elements, when assembled into a core, to form a polygonal cross-section. The assembled retaining portions have external retaining surfaces matching the polygonal cross-section. The retaining portions interact with matching receiving regions of an injection mold. In particular, this type of fixing in place counteracts twisting of the core within the injection mold.

The retaining surfaces may, moreover, be inclined towards the free end of the handlebar. In this way, a retaining portion may be provided, the polygonal cross-section of which is proximally of somewhat larger configuration and which distally has a somewhat smaller polygonal cross-section with the same number of vertices.

The polygonal cross-section of the core is conveniently a hexagonal cross-section.

### BRIEF DESCRIPTION OF THE DRAWINGS

The invention is illustrated below by way of example in drawings and described in detail with reference to several figures, in which:

FIG. 1 is a perspective view of a first core element for a handlebar, which is configured as;

FIG. 2 is a view of the first core element, as indicated in FIG. 1 with arrow II;

FIG. 3 is a perspective view of a structural component according to the invention in the form of a second core element for the handlebar;

FIG. 4 is a view of the second core element, as indicated in FIG. 3 with arrow IV;

FIG. 5 is a perspective view of the structural component according to the invention in the form of the handlebar;

FIG. 6 shows a detail according to section line VI-VI indicated in FIG. 5;

FIG. 7a shows an exemplary embodiment of the edges of the second core element as sealing edges according to section line VII-VII, as indicated in FIG. 3;

FIG. 7b shows a first alternative exemplary embodiment of the edges of the second core element according to section line VII-VII, as indicated in FIG. 3;

FIG. 7c shows a second alternative exemplary embodiment of the edges of the second core element according to section line VII-VII, as indicated in FIG. 3;

FIG. 7d shows a third alternative exemplary embodiment of the edges of the second core element according to section line VII-VII, as indicated in FIG. 3;

FIG. 8 is a scaled-down schematic plan view of a bicycle frame provided as a structural component according to the invention;

FIG. 9 is a schematic sectional view of the bicycle frame according to section line IX-IX, as indicated in FIG. 8; and

FIG. 10 shows an alternative bicycle frame fitted together from frame components configured as structural components according to the invention.

### DETAILED DESCRIPTION

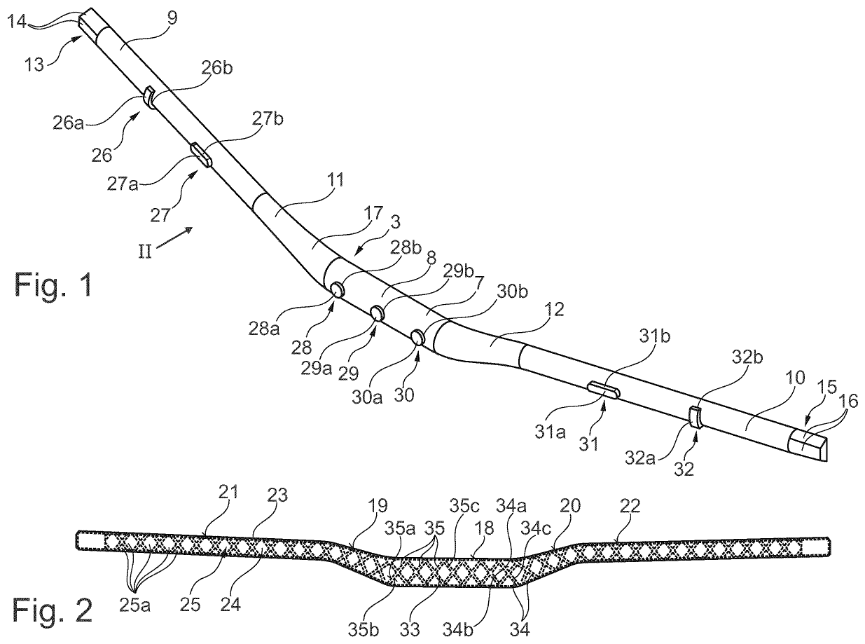

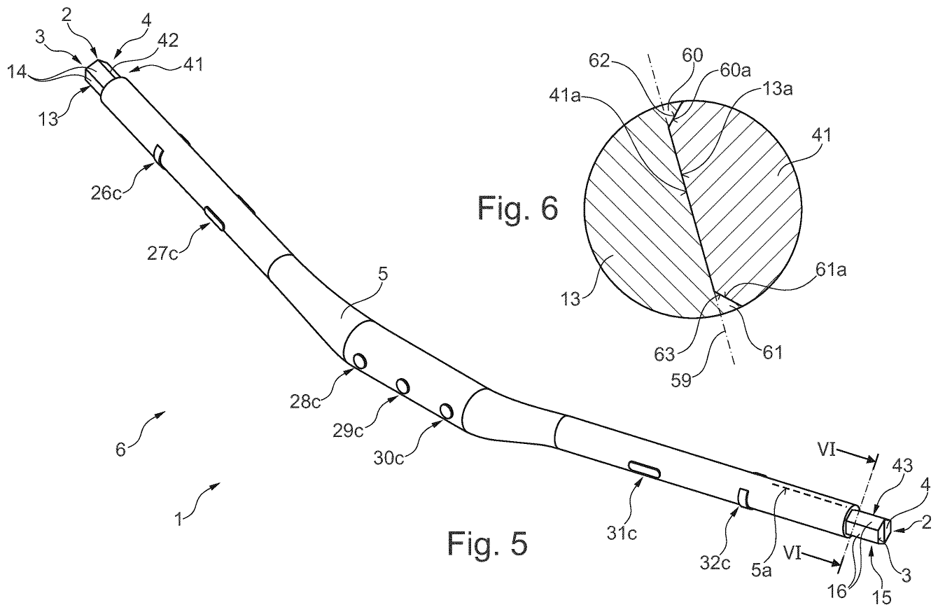

A first example of a bicycle structural component according to the invention is explained below with reference to FIGS. 1 to 5. The first example relates to bicycle a handlebar 1 embodied as a structural component. The substantially finished handlebar 1 is shown in FIG. 5. They comprise a core 2 which is assembled from two core elements 3 and 4 and surrounded by a shell element 5. The core elements 3 and 4 were molded from a thermoplastic plastics material in an injection mold and then assembled. The shell element 5 is likewise produced from a thermoplastic plastics material, specifically using a second injection mold into which the assembled core 2 has been previously inserted.

FIG. 1 depicts only the first, 3, of the core elements. In the finished handlebar 1, this is located on the front side 6 thereof, which in the installed state lies at the front in the direction of travel of the bicycle. The first core element 3 is provided with a central region 7, which has the largest cross-section. In the finished structural component, the central region 7 counts as a clamping region 8 of the handlebar 1 which, on the finished bicycle, interacts with a handlebar clamp bracket. Handlebar clamping is achieved with a stem element which for this purpose conventionally has a slotted stem lug. The finished handlebar 1 is configured to match such a stem lug. Using a conventional slot clamp, the stem lug can connect the clamping region 8 of the handlebar 1 to the stem element. The cross-section of the central region 7 of the core element 3 is therefore advantageously designed such that the clamping region of the finished handlebar structural component is compatible with conventional dimensions of a stem element/stem lug. Toward the ends thereof, the core element 3 is formed with a smaller cross-section than in the central region 7. The ends include two grip regions 9 and 10 of the finished handlebar structural component. On their respective outer sides, the grip region 9 has a subsurface 9a and the grip region 10 has a subsurface 10a. A transitional region 11 is provided between the grip region 9 and the central region 7 of the first core element 3, and a transitional region 12 is provided between the grip region 10 and the central region 7. On the outside, the transitional region 11 forms a subsurface 11a and the transitional region 12 forms a subsurface 12a. The transitional regions 11 and 12 provide a continuous change in cross-section, i.e., starting from the large cross-section of the central region 7, the cross-section decreases toward the grip regions 9 and 10. The subsurfaces 7a, 7a, 10a, 11a and 12a jointly form an outer surface 3a of the first core element 3. Moreover, a retaining portion 13 with retaining surfaces 14 is arranged at one free end of the first core element 3 and a retaining portion 15 with retaining surfaces 16 is arranged at the other free end. The retaining portions 13 and 15 are solid in the present example. They serve, principally at least, to fix the core element 3 in place in an injection mold for an injection molding process when it is assembled with the second core element 4 to form a core 2. The retaining portions 13 and 15 may either remain on the finished structural component after the injection molding process or alternatively be removed later.

The central region has a semi-cylindrical middle portion 18. This is adjoined on both sides by bisected conical portions 19 and 20 which form the transitional regions 11 and 12 respectively. The transitional regions 11 and 12 are each in turn adjoined by a semi-cylindrical portion 21 or 22 respectively, these each belonging respectively to one of grip regions 9 or 10. The portions together form a wall 23 of the first core element 3, on the inside 24 of which a channel-shaped cavity 25 is formed. The inside 24 of the wall 23 is largely parallel to the contour of the outer surface 3a.

Outwardly protruding position elements 26, 27, 28, 29, 30, 31 and 32 are arranged on the outer surface 3a. The position elements 26 have outer surfaces 26a, 27a, 28a, 29a, 30a, 31a and 32a, which fix the assembled core 2 in place in the mold cavity of an injection mold when it is inserted therein. The position elements act as spacers. To this end, the outer surfaces of the position elements come into contact, within the injection mold, with the inside of the closed mold cavity thereof. As a result of this contact, the core 2 keeps its shape and position during the injection molding process. This is also the case when the flowable starting material of the shell element 5 is fed into the mold cavity under high injection pressure. The exerted forces are able neither to deform the core 2 fixed in place in this way nor to modify its position within the mold cavity. A defined shell wall thickness of the shell element 5 can be produced in this way in the remaining mold cavity. In the grip region 9, the first core element 3 has two elongate position elements 26 and 27, one arranged distally and one proximally. The distally arranged elongate position element 26 extends in the circumferential direction of the outer surface 3a, while the proximally arranged elongate position element 27 extends parallel to a longitudinal direction of the grip region 9. The central region 7 has three punctiform position elements 28, 29 and 30 arranged in a row. Position elements 31 and 32 are arranged in mirror image in relation to position elements 26 and 27 and have a shape which corresponds to a mirror image thereof. The punctiform position elements 28, 29 and 30 are roughly cylindrical in shape. All the elongate and punctiform position elements are configured with oblique side surfaces 26b, 27b, 28b, 29b, 30b, 31b and 32b, these forming demolding bevels enabling simple removal of the first core element 3 from the injection mold.

FIG. 2 shows a simplified front view of the first core element 3, as indicated with the arrow II in FIG. 1. The figure is simplified in that the position elements of the circumferential surface are not shown in FIG. 2, to the advantage specifically of the depiction of the internal stiffening elements 33. The stiffening elements 33 are provided on the inside 24 of the channel-shaped cavity 25. In the present example, the stiffening elements 33 are parallel ribs 34 which intersect with parallel ribs 35, so boosting the stiffening effect thereof. The intersecting ribs 34 and 35 subdivide the channel-shaped cavity 25 into numerous small cavities 25a. The ribs 34 are embodied with oblique lateral rib surfaces 34a and 34b and the ribs 35 are embodied with oblique lateral rib surfaces 35a and 35b, these acting as demolding bevels to assist in demolding the core element 3 from the injection mold. The front view of the first core element 3 indicates that the finished handlebar structural component comprises riser-shaped handlebar 1. The grip regions 9 and 10 thereof are arranged with a slight difference in height (rise) relative to the central region 7.

The thickness shown in FIG. 2 of the wall 23 of the core element 3 in the region of the circumferential surface 7 thereof should be understood as being schematic and not necessarily in proportion with the handlebar diameters in the various portions thereof. In practice, the wall 23 is sufficiently thick for an assembled core 2 to be able to withstand a high injection pressure when it is inserted into the injection mold as a permanent core for molding the shell element 5.

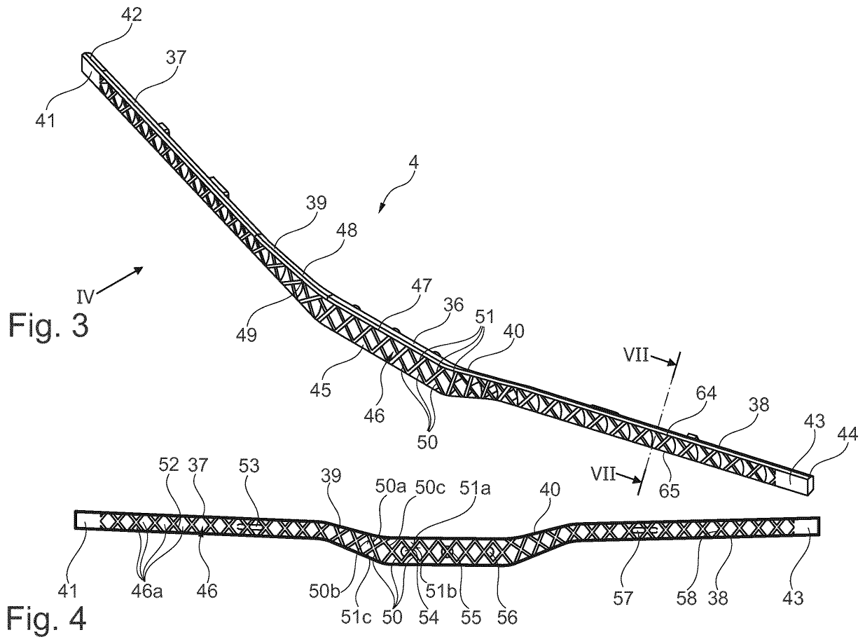

FIG. 3 shows a perspective view of the second core element 4 which is configured to be complementary to the first core element 3. The second core element 4 is located in the finished handlebar 1 at the rear side thereof, which, in the installed state, lies toward the back in the direction of travel of the bicycle. The second core element 4 has constituent parts which are complementary to the first core element 3. It is likewise provided with a central region 36 for the handlebar clamp bracket. Toward the two ends of the second core element 4, two grip regions 37 and 38 are provided which are likewise of smaller cross-section than the central region 36. A transitional region 39 or 40 respectively is provided between each of the grip regions and the central region of the second core element 4. The transitional region 39 produces a continuous change in cross-section between the large cross-section of the central region 36 and the smaller cross-section of the grip region 37 as well as between the large cross-section of the central region 36 and the smaller cross-section of the grip region 38. At each of the free ends, the second core element 4 respectively has a retaining portion 41 with retaining surfaces 42 or a retaining portion 43 with retaining surfaces 44, which serve to fix the second core element 4 in place in an injection mold when assembled with the first core element 3 to form a core 2. The retaining portions 41 and 43 of the second core element 4 are likewise solid in the present example.

The perspective view of FIG. 3 offers a view of the inside 45 which forms a channel-like cavity 46. The inside 45 constitutes part of a wall 47 which, externally, forms an outer surface 4a. The outer surface 4a supplements the outer surface 3a of the first core element 3; together these form a circumferential surface 2a of the core 2. The outer surface 4a is in principle likewise assembled from subsurfaces, like those portions of the first core element 3. Inner stiffening elements 49 are arranged in the channel-shaped cavity 46 of the second core element 4, and are configured as parallel ribs 50 which intersect with parallel ribs 51, so improving the stiffening effect. The ribs 50 are embodied with oblique lateral rib surfaces 50a and 50b and the ribs 51 are embodied with oblique lateral rib surfaces 51a and 51b, these acting as demolding bevels to assist in demolding the second core element 4 from the injection mold. In this case, the channel-shaped cavity 46 is subdivided into numerous small cavities 46a. The ribs 50 and 51 of the second core element 4 are likewise embodied with oblique lateral rib surfaces 50a and 50b and 51a and 51b which, as demolding bevels, assist in demolding the second core element 4 from the injection mold. Moreover, the ribs 34 and 35 of the first core element 3 and the ribs 50 and 51 of the second core element 4 are arranged congruently when assembled. The core element 3 has abutment surfaces 34c and 35c which are in contact with abutment surfaces 50c and 51c of the second core element 4 when the two core elements are assembled. The core 2, which is assembled from these two core elements 3 and 4, can absorb very high pressure forces by way of the mutually abutting ribs when forces act externally on the outer surface 3a of the first core element 3 and on the outer surface 4a of the second core element 4 and pressure forces are transferred into the ribs.

FIG. 4 shows a front view of the second core element 4, as indicated with the arrow IV in FIG. 3. The figure shows the internal stiffening elements 49 embodied as intersecting ribs 50 and 51. Moreover, position elements 52, 53, 53, 55, 56, 57 and 58 are shown by hidden dashed lines. In this view, the position elements are located on the rear outer surface 48 of the illustrated second core element 4.

In the grip region 37, the second core element 4 has two elongate position elements 52 and 53, one arranged distally and one proximally. The distally arranged elongate position element 52 extends in the circumferential direction of the outer surface 48a, while the proximally arranged elongate position element 53 extends parallel to a longitudinal direction of the grip region 37. The central region 36 has three punctiform position elements 54, 55 and 56 arranged in a row. Position elements 57 and 58 are arranged in mirror image in relation to position elements 52 and 53 and have a shape which corresponds to a mirror image thereof. The punctiform position elements 54, 55 and 56 are roughly cylindrical in shape. All the elongate and punctiform position elements are configured with oblique side surfaces 52b, 53b, 54b, 55b, 56b, 57b and 58b, these forming demolding bevels enabling simple removal of the second core element 4 from the injection mold.

FIG. 5 shows the handlebar 1 as a finished structural component. On the inside, this comprises the first core element 3 and the second core element 4 which are assembled to form the core 2 and, on the outside, it comprises the shell element 5. The shell element 5 was injection molded around the permanent core 2 using the above-mentioned second injection mold. During the process of injection-molding the shell element 5, the entire circumferential surface of the assembled core 2 was melted and so materially bonded together with the starting material of the shell element 5 on the inside 5a thereof; the inner surface 5a is indicated in FIG. 5 by a dashed line. Moreover, position elements (26, 27, 28, 29, 30, 31, 32, 52, 53, 53, 55, 56, 57, 58) provided on the outer surfaces 3a and 4a of core elements 3 and 4 were laterally surrounded by the starting material of the shell element 5. In this way, an additional interlocking connection was provided between the position elements and the shell element 5. Outer surfaces (26c, 27c, 28c, 29c, 30c, 31c) of the position elements are visible on the finished handlebar because they were in contact with the mold cavity of the injection mold during the injection molding process. They were not to be covered with the starting material of the shell element 5 during injection molding and therefore remain visible.

The assembled retaining portions 13/41 and 15/43, which in each case form a hexagonal cross-section, are located at the free ends of the finished structural component. The retaining portions are solid in the present example. When assembled, three retaining surfaces 14 and three retaining surfaces 42 form a retaining surface hexagon. All six retaining surfaces are arranged inclined at a slight wedge angle. In this way, the hexagonal cross-section of the assembled retaining portions 13/41 is proximally somewhat greater and somewhat smaller at the distal free end. The assembled retaining portions 15/43 together likewise form six retaining surfaces, which are arranged inclined at a slight wedge angle.

The section line VI-VI indicated in FIG. 5 indicates a detail which is shown on an enlarged scale in FIG. 6. The detail shows that, in the region of retaining portions 13/41, interacting means are provided which position the complementary core elements 3 and 4 correctly relative to one another. The retaining portions 13/41 each have an internal base surface 13a or 41a respectively, which are in mutual contact in a parting plane 59 when assembled. In the case of the retaining portion 13 of the first core element 3, the base surface 13a is laterally delimited by centering fins 60 and 61. The centering fins have centering surfaces 60a and 61a arranged inclined relative to one another in a V shape. The retaining portion 41 of the second core element 4 has centering chamfers 62 and 63 arranged laterally on the base surface 41a thereof, these being configured to match the centering fins 60 and 61 of the first core element 3. This enables undesired lateral displacement of the core elements 3 and 4 relative to one another to be counteracted.

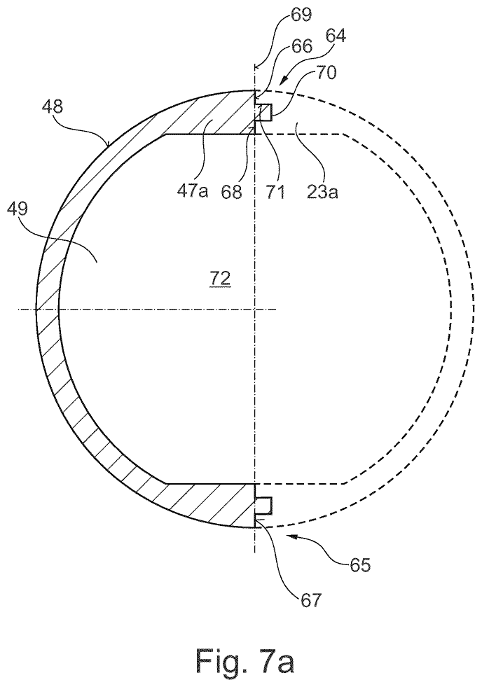

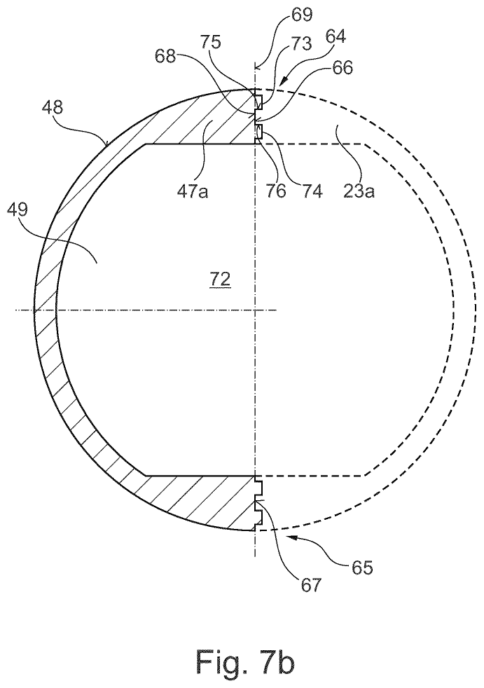

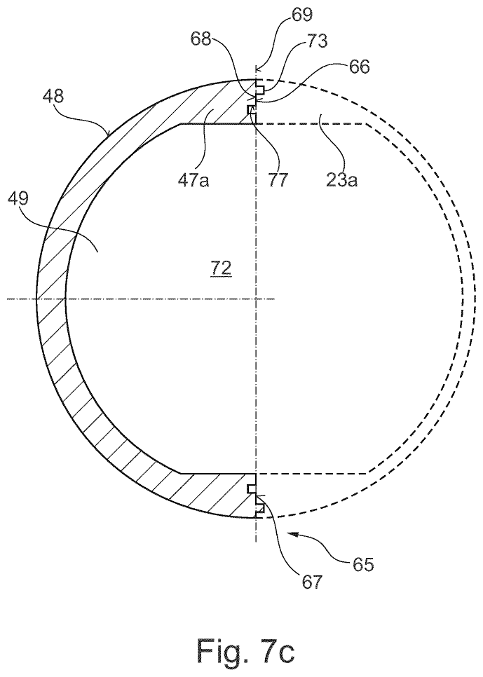

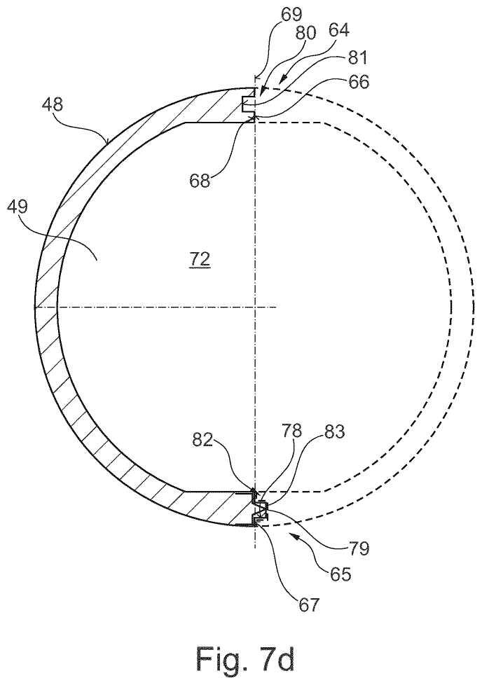

FIG. 7a is an enlarged representation of a detail which relates to the configuration of edges 64 and 65 of the second core element 4, specifically according to section line VII-VII, indicated in FIG. 3. The edges are provided with sealing means. For simplicity of explanation, the first core element 3 is shown by dashed lines, specifically fitted together with the second core element 4. The depicted edges 64 and 65 of the second core element 4 each have an abutment surface 66 and 67 respectively, which interact with abutment surfaces of the first core element 3. The abutment surface 66 is, for example, in contact with an abutment surface 68 of the first core element 3 and forms a parting joint 69 therewith.

By way of the example of the parting joint 69, FIG. 7a shows that the abutment surface 66 of the second core element 4 is further developed and has as sealing means S1 a sealing edge 66a which is provided for this purpose with a tongue profile 70. Matching this, the abutment surface 68 of the first core element 3 is provided with a sealing means S2, which also takes the form of a sealing edge 68a which has a groove profile 71. When the sealing edges 66a and 68a are fitted together, a good sealing effect is obtained by way of the tongue profile 70 and the groove profile 71. According to the same principle, the abutment surface 67 of the second core element 4 interacts with the associated abutment surface of the first core element 3. In this way, the core 2 assembled from the two core elements 3 and 4 can be used as a permanent core in an injection mold. In the injection mold, the shell element 5 is injection molded around the core 2 with a given injection pressure. It is necessary, in the process, to prevent molten starting material of the shell element 5 from penetrating into a parting joint and possibly reaching a cavity 72 of the core 2, or indeed the cavities 25a and 46a respectively between the ribs of the core elements 3 and 4 respectively. In particular, a high injection pressure may be used to injection mold the shell element 5, as a high injection pressure is beneficial to the quality of the shell element 5 produced.

In the region of the tongue profile 70, the wall 47 of the second core element 4 has a thickened portion 47a. The tongue profile 70 is, moreover, arranged such that it protrudes from the abutment surface 66. Its shape makes it possible to produce the second core element 4 by injection molding in an injection mold. To this end, the tongue profile 70 is configured with lateral demolding bevels 70a and 70b, to make it easy to remove the second core element 4 from the injection mold.

The groove profile 71 of the first core element 3 takes the form of a recess in the abutment surface 68 thereof. In the region of the groove profile 71, the wall 23 is provided with a thickened portion 23a. The groove profile is likewise designed for production of the first core element by injection molding in an injection mold. For this purpose, the groove profile has lateral demolding bevels, to assist in demolding the first core element 3 from the injection mold.

FIG. 7b shows an alternative configuration for the edges 64 and 65 of the second core element which likewise provide sealing means S1 and S2 in the form of interlocking sealing edges. The view likewise relates to section line VII-VII, indicated in FIG. 3. The complementary core elements 3 and 4 have pairs of abutment surfaces 66/68 forming a parting joint 69. In contrast to FIG. 7a, the second core element 4 of FIG. 7b has two tongue profiles 73 and 74 next to one another on its abutment surface 67.

To match these, the first core element shown by dashed lines is provided on its abutment surface 68 with groove profiles 75 and 76 arranged next to one another. The twin tongue profiles 73 and 74 and the twin groove profiles 75 and 76 are configured such that core elements 3 and 4 can likewise be produced by injection molding in an injection mold. The twin groove and tongue profiles improve the sealing effect over the previous example shown in FIG. 7a.

FIG. 7c shows a further alternative configuration of the edges 64 and 65 of the second core element 4 which likewise provide sealing means S1 and S2 by way of interlocking sealing edges. The view again relates to section line VII-VII of FIG. 3. The first core element 3 that fits therewith is shown as a dashed line. The two complementary core elements 3 and 4 have abutment surfaces 66 and 68 respectively, which interact as a pair at the parting joint 69. The abutment surfaces are further developed as sealing edges 66a and 68a respectively, which are based on the configuration of the example of FIG. 7b. There is a difference, however, in that one of the twin tongue profiles is replaced on the sealing edge 66a of the second core element 4 by a groove profile 77. To match this, a groove profile is replaced on the sealing edge 68a of the first core element 3 by a tongue profile 78.

The edge 65 of the second core element 4 is modified in the same way as edge 64 thereof. This also applies to the associated edge of the first core element.

Each abutment surface 64 and 65 of the second core element 4 thus has one tongue profile and one groove profile. To match these, each abutment surface of the first core element shown by dashed lines has one groove profile and one tongue profile. The combination of one tongue profile and one groove profile per abutment surface improves the sealing effect.

FIG. 7d shows a fourth example of a configuration of the edges 64 and 65 of the second core element 4 which is provided with a sealing means S1 and S2 respectively in the form of special sealing edges. The view also relates to section line VII-VII of FIG. 3. The first core element 3 is again shown as a dashed line. The two complementary core elements 3 and 4 have sealing edges at the abutment surfaces which come into contact at a parting joint 69. The second core element 4 is provided at an abutment surface 67 with a wedge profile 78 having a protruding wedge tip 79. The abutment surface 66 of the second core element 4, on the other hand, has groove profile 80 with a groove base 81 which is arranged parallel to the abutment surface 66. The dashed first core element 3 is provided with a groove profile 82 which interacts with the wedge profile 78 of the second core element 4. The groove profile 82 likewise has a groove base 83, which is arranged parallel to the corresponding abutment surface of the first core element 3. The wedge tip 79 of the wedge profile 78 interacts with the groove profile 82 of the first core element 3. According to FIG. 7d, the wedge profile 78 can be seen to project from the abutment surface 67 by an amount which is greater than the depth dimension of the associated groove profile 82. This means that, when fitted together, the wedge tip 79 presses against the groove base 83 and forms a notch therein. Formation of the notch in the groove base 83 is accompanied by a degree of deformation of the wedge tip 79. A good sealing effect is thereby achieved. The first core element 3 is likewise provided with a wedge profile with wedge tip, which wedge profile interacts with the groove base 81 of the groove profile 80 of the second core element 4 in the same notch-forming, sealing manner.

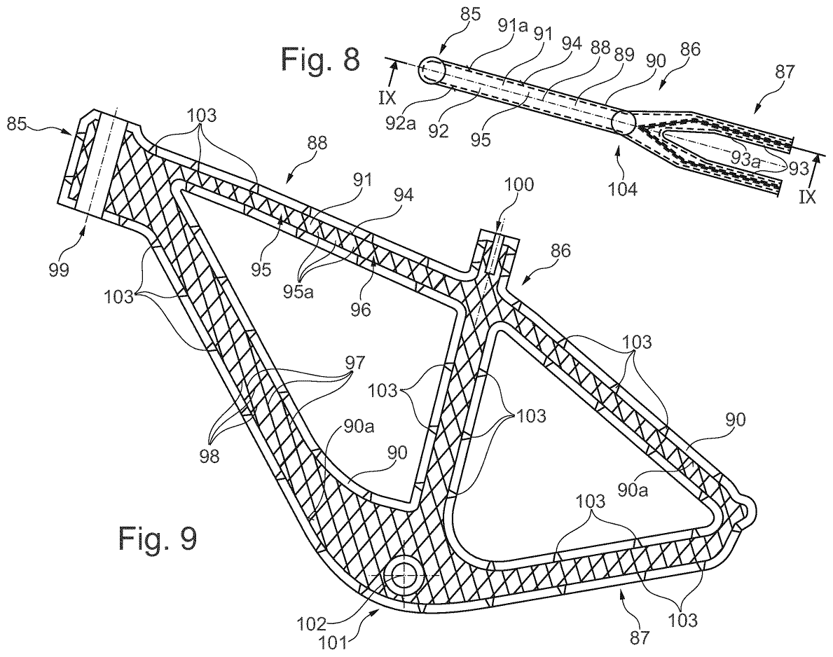

FIG. 8 is a schematic, scaled-down representation of a plan view of a bicycle frame 84. The bicycle frame is configured as a structural component according to the invention. The plan view shows a head tube portion 85, a seat tube portion 86 and a back end portion 87 of the bicycle frame. Moreover, a connecting top tube element 88 is apparent between the head tube portion 85 and the seat tube portion 86.

FIG. 9 shows a schematic sectional view through the bicycle frame 84 of FIG. 8. The sectional view follows the course of section line IX-IX shown in FIG. 8. Because the bicycle frame 84 is constructed as a structural component according to the invention, it has a supporting core 89 and a supporting shell element 90, the inner surface 90a of which is materially bonded to the core 89. The shell element 90 is produced in one piece from a thermoplastic plastics material in an injection mold. The core 89 is assembled from three core elements. When assembled, the core was inserted as a permanent core 89 into the injection mold. To produce the shell element 90, the starting material for the shell element 90 is (injection) molded around the inserted core 89. FIG. 8 shows a first core element as a dashed line. The first core element is configured as a right-hand side core element 91 and is assigned to the right-hand side of the bicycle frame 84. The right-hand side core element 91 is also that side core element which is depicted in the sectional representation of FIG. 9. The second core element is a mirror-image, left-hand version of the first core element, i.e., a left-hand side core element 92. The third core element is an additional back end core element 93, which is likewise shown as a dashed line in FIG. 8.

In this example, the back end core element 93 is roughly V-shaped when viewed from above in the plan view according to FIG. 8. In this way, it complements both the right-hand side core element 91 and the left-hand side core element 92 in the region of the back end portion 87. Alternatively, the back end core element 93 may likewise be subdivided into a right-hand back end core element and a left-hand back end core element, with the core 89 then being assembled from a total of four core elements.

The right-hand side core element 91 has a smooth outer surface 91a facing the shell element 5 and forms a cavity 95 facing away from the shell element 5. The left-hand side core element 92 has a smooth outer surface 92a and the back end core element 93 has a smooth outer surface 93a. The three stated outer surfaces 91a, 92a and 93a together form a circumferential surface 89a of the assembled core 89. In the region of the cavity 95, internal stiffening elements 96 are arranged in the form of ribs 97 and 98 which intersect. The cavity 95 is subdivided by the ribs into numerous small cavities 95a. An opening 99 for a fork or for a headset is provided in the region of the head tube portion 85 and an opening 100 for a seatpost is provided in the region of the seat tube portion 86. Furthermore, a bottom bracket portion 101 is provided which has an opening 102 for a pedal crank bearing system. The opening 99 for the headset and/or the opening 100 for the seatpost and/or the opening 102 for the pedal crank bearing system may take the form of a sleeve body which, like the core 89, can be inserted into the injection mold. Such a sleeve body may be made of plastics or a metal, for example an aluminum tube.

The assembled core 89 has parting joints between the individual assembled core elements, i.e., the right-hand side core element 91, left-hand side core element 92 and the back end core element 93. The parting joints take the form of sealing edges, according to one of the principles proposed and described with reference to FIGS. 7a-7d. In this way, the assembled core 89 is sealed at the parting joints in such a way that, during injection molding of the shell element 90, no flowable starting material can penetrate into the core 89, or into the cavity 95, or indeed cavities 95a, thereof.

The outer surface 91a of the right-hand side core element 91 is provided with protruding position elements 103. The left-hand side core element 92 and the back end core element 93 are likewise provided with position elements on their outer surfaces 92a and 93a. In this way, the assembled core 89 can be fixed correctly in place within the injection mold. Precisely oriented positioning of the core 89 assists the production of a correct wall thickness for the shell element 90.

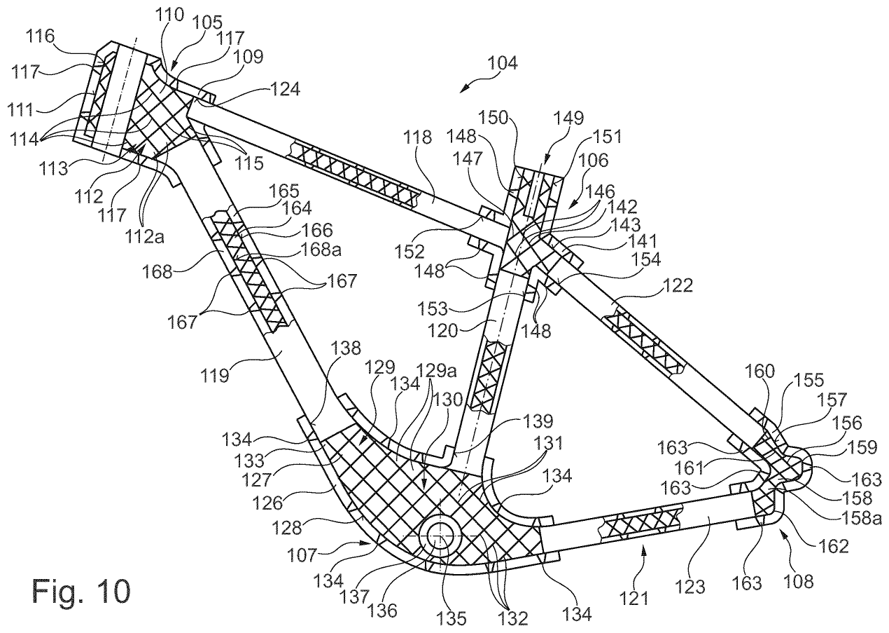

FIG. 10 depicts a sectional view of an alternative bicycle frame 104. This bicycle frame is fitted together in modular manner from frame components. At least one of the frame components of the bicycle frame 104 has to take the form of the structural component according to the invention, i.e., it must have one structurally supporting shell element and one structurally supporting core. In the present example, all the frame components of the bicycle frame 104 take the form of structural components.

Five of the structural components of FIG. 10 are configured as node elements and a further seven structural components are configured as frame elements provided as connecting members between the node elements. The node elements include a head tube node element 105, a seat tube node element 106, a bottom bracket node element 107 and two dropout node elements, of which the right-hand dropout node element 108 is visible in FIG. 10. The dropout node element 108 comprises a fork end or has a means of being able to accommodate a mountable fork end.

The structure of the node elements (105, 106, 107, 108) is explained by way of example with reference to the head tube node element 105, which is visible in the sectional representation of FIG. 10. This head tube node element 105 comprises a shell element 109, which is produced in an injection mold, and a core, which is assembled from a left-hand head tube core element and a right-hand head tube core element. The sectional representation of FIG. 10 shows the right-hand head tube core element 110, which has a smooth circumferential surface 111 facing the shell element 109 and forms a cavity 112 on its side remote from the shell element 109. In the region of the cavity 112, internal stiffening elements 113 are provided in the form of ribs 114 and 115 which intersect. The cavity 112 is subdivided by the ribs into numerous small cavities 112a. Furthermore, edges of the two head tube core elements, such as the edge 116 of head tube core element 110, are provided with sealing means. The sealing means advantageously take the form of mechanically interacting sealing edges for the assembled circumferential surface, specifically according to the principles as described above as alternatives to the sealing edges of the core elements of the handlebar according to FIGS. 1 to 7d. Reference is here made to these alternatives. Position elements 117 are arranged on the circumferential surface of the core or of the illustrated head tube core element 110, these serving as spacers when the assembled core is inserted into the injection mold in order to produce the shell element 109. The position elements 117 fix the shape and position of the head tube core element 105 or of the assembled core within the injection mold according to the principles likewise explained in detail above with reference to the handlebar according to FIGS. 1 to 5, to which reference is made.

Furthermore, the head tube node element 105 has a receiving means 118 for a fork, so as to mount a front wheel, or the receiving means 118 serves to accommodate a headset for a front wheel fork. Advantageously, the receiving means 118 is provided with an opening 119. The opening 119 can be produced using two half-shell constituent parts, each of which half-shell constituent parts belongs to one of the two core elements. Alternatively, the opening may be provided at the time of production of the shell element 109 in an injection mold by way of a sleeve body which is inserted into the injection mold just like the core. Such a sleeve body may be made of a plastics material or a metal, for example an aluminum tube.

The head tube node element 105 is connected to the seat tube node element 106, specifically by way of a frame element configured as a top tube frame element 118. Furthermore, the head tube node element 105 is connected to the bottom bracket node element 107 by way of a down tube frame element 119. A connection by way of a seat tube frame element 120 is provided between the seat tube node element 106 and the bottom bracket node element 107. A back end portion 121 of this bicycle frame comprises the dropout node elements, which are arranged spacedly adjacent one another so as to provide space therebetween to accommodate a rear wheel. The sectional representation of FIG. 10 shows said right-hand dropout node elements 108. This dropout node element 108 is connected on the one hand by way of a seat stay frame element 122 to the seat tube node element 106 and on the other hand by way of a chain stay 123 to the bottom bracket node element 107.

Because the bicycle frame 104 is constructed in modular fashion using the frame components, means are provided for providing precise positioning between node element and frame element. To this end, each node element has a fusion region, which is configured to match a connecting means of the frame element. If a further frame element needs to be added to the same node element, this node element is advantageously provided with a further fusion region for the further frame element, which in turn has a matching connecting means for the further fusion region.

In this context, the head tube node element 105 is provided with a top tube fusion region for joining to the top tube frame element 118. Moreover, the head tube node element 105 is provided with a down tube fusion region 125 for joining to the down tube frame element 119.

Furthermore, it is convenient to provide a materially bonding connecting means in the form of an additional material, in order to produce a firm connection of the head tube node element 105 to the fitted top tube frame element 118 and the fitted down tube frame element 119. The additional material is an adhesive, for example. A gap for the adhesive (bond gap) is formed between the frame components to be connected together. For this purpose, the relevant fusion region of the head tube node element and the connection region of the associated frame element advantageously each provide an appropriate bonding surface. The bonding surfaces are such that the bond gap has gap dimensions which match the selected adhesive in order to provide the necessary adhesive bond strength.

The head tube node element 105 is simply constructed in the manner of a lug, which has inner fusion regions (124, 125) with an internal bonding surface. To match this, the top tube frame element 118 or the down tube frame element 119 respectively can be provided with outward facing connection regions 118a and 119a respectively which form bonding surfaces which fit together with the associated internal bonding surfaces of the head tube node element 105 in order to form the required bond gap for the adhesive.

The bottom bracket node element 107, like the head tube node element 105, is formed from a shell element 126 which is injection molded around a core and the inner surface 126a of which is thereby materially bonded to the core, the core being assembled from a left-hand bottom bracket core element and a right-hand bottom bracket core element. The sectional representation of FIG. 10 shows the right-hand bottom bracket core element 127. This has a smooth circumferential surface 128 facing the shell element 126 and forms a cavity 129 on its side remote from the shell element 126. In the region of the cavity 129, internal stiffening elements 130 are provided in the form of ribs 131 and 132 which intersect. The cavity 129 is subdivided by the ribs into numerous small cavities 129a. One edge 133 of the right-hand bottom bracket core element 127 has a sealing means in the form of a sealing edge which interacts with an associated sealing edge of the left-hand bottom bracket core element. In this way, a tight parting joint of the assembled core is formed in this region, specifically according to the principles described above as alternatives for the sealing edges of the core elements of the handlebar according to FIGS. 1 to 7d and to which reference is made. Position elements 134 are arranged on the circumferential surface of the core or of the depicted right-hand bottom bracket core element 127, these acting as spacers when the core is inserted into the injection mold to produce the shell element 126. The position elements 134 fix the shape and position of the bottom bracket core element 127 or of the assembled core within the injection mold according to the principles likewise explained in detail above with reference to the handlebar according to FIGS. 1 to 5, to which reference is made.

Furthermore, the bottom bracket node element 107 has receiving means 135 for a pedal crank, or for a pedal crank bearing system. Advantageously, the receiving means is provided with an opening 136 which can accommodate the pedal crank bearing system. The opening 136 may be produced using two sleeve-type constituent parts, each of which sleeve-type constituent parts belongs to one of the two bottom bracket core elements; FIG. 10 contains the right-hand sleeve-type constituent part 137 of the receiving means 135 for the pedal crank bearing system. Alternatively, the opening 136 may be provided at the time of production of the shell element 126 in an injection mold, by way of an advantageously one-piece sleeve body which is inserted into the injection mold just like the core. Such a sleeve body may be made of a plastics material or a metal, for example an aluminum tube. Furthermore, the bottom bracket node element 107 is provided with four fusion regions for joining frame elements, specifically one fusion region 138 for the down tube frame element 119 and one fusion region 139 for the seat tube frame element 120 as well as two fusion regions 140 for the back end portion 121, in each case for joining a chain stay frame element 123.

Like the head tube node element 105, the seat tube node element 106 is formed from a shell element 141 which is injection molded around a core and the inner surface 141a of which is thereby materially bonded to the core, wherein the core is assembled from a left-hand seat tube core element and a right-hand seat tube core element, of which only the right-hand seat tube core element 142 is visible in FIG. 10. This has a smooth circumferential surface 143 facing the shell element 141 and forms a cavity 144 on its side remote from the shell element. In the region of the cavity 144, internal stiffening elements 145 are provided in the form of ribs 146 and 147 which intersect. The cavity 146 is subdivided by the ribs into numerous small cavities 144a. The edge of the seat tube core element 142 is provided with a sealing means in the form of a sealing edge which interacts with an associated sealing edge of the left-hand seat tube core element. In this way, a tight parting joint of the assembled core is formed in this region, specifically according to the principles described above as alternatives for the sealing edges of the core elements of the handlebar according to FIGS. 1 to 7d and to which reference is made. Position elements 148 are arranged on the circumferential surface of the core or of the depicted right-hand seat tube core element 142, these acting as spacers when the core is inserted into the injection mold to produce the shell element 141. The position elements 148 fix the shape and position of the seat tube core element 142 or of the assembled core within the injection mold according to the principles likewise explained in detail above with reference to the handlebar according to FIGS. 1 to 5, to which reference is made.

The seat tube node element 142 additionally has a receiving means 149 for a seatpost. Advantageously, the receiving means is provided with an opening 150 which can be produced using two sleeve-type constituent parts, of which in each case one sleeve-type constituent part belongs to one of the two seat tube core elements; FIG. 10 contains the right-hand sleeve-type constituent part 151 of the receiving means 149 for the seatpost. Alternatively, the receiving means, or the opening 150, may be provided at the time of production of the shell element 141 in an injection mold, by way of an advantageously one-piece sleeve body which is inserted into the injection mold just like the core. Such a sleeve body may be made of a plastics material or a metal, for example an aluminum tube.

Furthermore, the seat tube node element 106 is provided with five fusion regions for joining frame elements, specifically one fusion region 152 for the top tube frame element 118 and one fusion region 153 for the seat tube frame element 120 as well as two fusion regions 154 for the back end portion 121, in each case for joining a seat stay frame element 122.

The right-hand dropout node element 108 has a shell element 155 which is injection molded around a core and the inner surface 155a of which is materially bonded thereto, the core being assembled from a left-hand dropout core element and a right-hand dropout core element. FIG. 10 shows the right-hand dropout core element 156. This has a smooth circumferential surface 157 facing the shell element 155 and forms a cavity 158 on its side remote from the shell element 155 In the region of the cavity 158, internal stiffening elements 159 are provided in the form of ribs 160 and 161 which intersect.

The frame elements, such as the top tube frame element 118, down tube frame element 119, seat tube frame element 120, seat stay frame elements 122 and chain stay frame elements 123, are likewise configured in the present example as structural components according to the invention and in each case have a structurally supporting shell element and a structurally supporting core advantageously assembled from core elements. The structure of the stated frame elements is explained by way of example with reference to the down tube frame element 119. This has a core assembled from two down tube core elements, of which the right-hand down tube core element 164 is depicted. The down tube core elements are advantageously produced in an injection mold and preferably from thermoplastic plastics material. One edge 165 of the right-hand down tube core element 164 has a sealing means in the form of a sealing edge which interacts with an associated sealing edge of the left-hand down tube core element. In this way, a tight parting joint of the assembled core of the right-hand down tube frame element 119 is formed in this region, specifically according to the principles described above as alternatives for the sealing edges of the core elements of the handlebar according to FIGS. 1 to 7d and to which reference is made. Position elements 167 serving as spacers are arranged on one circumferential surface 166 of the core of the depicted right-hand down tube core element 164. The core is then inserted into an injection mold for the purpose of producing a shell element 168 which is injection molded around the core and the inner surface 168a of which materially bonds to the circumferential surface 166 of the core. The position elements 167 fix the shape and position of the down tube core element 164 or of the assembled core within the injection mold according to the principles likewise explained in detail above with reference to the handlebar according to FIGS. 1 to 5, to which reference is made.

The other frame elements configured as structural components, such as the top tube frame element 118, seat tube frame element 120, seat stay frame elements 122 and chain stay frame elements 123, in principle have an identical structure to that of the down tube frame element 119.

### LIST OF REFERENCE NUMERALS

1 Handlebar
2 Core
2a Circumferential surface
3 Core element
3a Outer surface
4 Core element
4a Outer surface
5 Shell element
5a Inner surface
6 Front side
7 Central region
7a Subsurface
8 Clamping region
9 Grip region
9a Subsurface
10 Grip region
10a Subsurface
11 Transitional region
11a Subsurface
12 Transitional region
12a Subsurface
13 Retaining portion
14 Retaining surface
15 Retaining portion
16 Retaining surface
18 Middle portion
19 Bisected conical portion
20 Bisected conical portion
21 Bisected conical portion
22 Bisected conical portion
23 Wall
23a Thickened portion
24 Inside
25 Channel-type cavity
25a Small cavity
26 Position element
26a Outer surface
27 Position element
27a Outer surface
28 Position element
28a Outer surface
29 Position element
29a Outer surface
30 Position element
30a Outer surface
31 Position element
31a Outer surface
32 Position element
32a Outer surface
33 Stiffening element
34 Ribs
34a Rib surface
34b Rib surface
34c Abutment surface
35 Ribs
35a Rib surface
35b Rib surface
35c Abutment surface
36 Central region
37 Grip region
38 Grip region
39 Transitional region
40 Transitional region
41 Retaining portion
42 Retaining surface
43 Retaining portion
44 Retaining surface
45 Inside
46 Channel-type cavity
46a Small cavity
47 Wall
47a Thickened portion
48 Outer surface
49 Stiffening element
50 Rib
50a Rib surface
50b Rib surface
51 Rib
51a Rib surface
51b Rib surface
52 Position element
53 Position element
54 Position element
55 Position element
56 Position element
57 Position element
58 Position element
59 Parting plane
60 Centering fin
60a Centering surface
61 Centering fin
61a Centering surface
62 Centering chamfer
63 Centering chamfer
64 Edge
65 Edge
66 Abutment surface (second core element)
66a Sealing edge
67 Abutment surface (second core element)
68 Abutment surface (first core element)
68a Sealing edge (first core element)
69 Parting joint
70 Tongue profile
71 Groove profile
72 Cavity
73 Tongue profile
74 Tongue profile
75 Groove profile
76 Groove profile
77 Groove profile
78 Wedge profile
79 Wedge tip
80 Groove profile
81 Groove base
82 Groove profile
83 Groove base
84 Bicycle frame
85 Head tube portion
86 Seat tube portion
87 Back end portion
88 Top tube element
89 Core
89a Circumferential surface
90 Shell element
90a Inner surface
91 Side core element, right-hand
91a Outer surface
92 Side core element, left-hand
92a Outer surface
93 Back end core element
93a Outer surface
95 Cavity
95a Small cavity
96 Stiffening element
97 Ribs
98 Ribs
99 Opening (headset)
100 Opening, seatpost
101 Bottom bracket portion
102 Opening (pedal crank bearing system)
103 Position element
104 Bicycle frame
105 Head tube node element
106 Seat tube node element
107 Bottom bracket node element
108 Dropout node element
109 Shell element
110 Right-hand head tube core element
111 Circumferential surface
112 Cavity
112a Small cavity
113 Stiffening element
114 Rib
115 Rib
116 Edge
117 Position element
118 Top tube frame element
118a Connection region
119 Down tube frame element
119a Connection region
120 Seat tube frame element
121 Back end portion
122 Seat stay frame element
123 Chain stay frame element
124 Top tube fusion portion
125 Down tube fusion region
126 Shell element (bottom bracket node)
126a Inner surface
127 Pedal crank core element
128 Circumferential surface
129 Cavity
129a Small cavity
130 Stiffening element
131 Rib
132 Rib
133 Edge
134 Position element
135 Receiving means
136 Opening
137 Sleeve-type constituent part
138 Fusion region, down tube
139 Fusion region, seat tube
140 Fusion region, chain stay
141 Shell element (seat tube core element)
141a Inner surface
142 Seat tube core element
143 Circumferential surface
144 Cavity
144a Cavity
145 Stiffening element
146 Rib
147 Rib
148 Position element
149 Receiving means
150 Opening
151 Sleeve-type constituent part
152 Fusion region, top tube
153 Fusion region, seat tube
154 Fusion region, seat stay
155 Shell element
155a Inner surface
156 Dropout core element, right-hand
157 Circumferential surface
158 Cavity
158a Cavity
159 Stiffening element
160 Rib
161 Rib
162 Edge
163 Position element
164 Down tube core element
165 Edge
166 Circumferential surface
167 Position element
168 Shell element
168a Inner surface
S1 Sealing means
S2 Sealing means

What is claimed is:

1-24. (canceled)

25. A structural component of a bicycle comprising a core having at least one cavity and one encasing circumferential surface, and comprising a shell element, with the proviso that both the core and the shell element in each case have a structurally supporting function, and the supporting function is reinforced by way of a material bond between the encasing circumferential surface of the supporting core and an inner surface of the supporting shell element.

26. The structural component according to claim 25, wherein either the core and/or the shell element is produced using a starting material which is flowable in a plastic state within the mold cavity of a shaping mold.

27. The structural component according to claim 25, wherein the starting material is a thermoplastic plastics material.

28. The structural component according to claim 25, wherein the core is a one-piece configuration or assembled from a plurality of core elements.

29. The structural component according to claim 28, wherein each core element has an outer surface and edges, and wherein the outer surfaces of a plurality of core elements form the circumferential surface of the core when assembled.

30. The structural component according to claim 28, wherein a parting joint is formed at edges of the outer surfaces of assembled core elements, and wherein a sealing means is provided for the parting joint.

31. The structural component according to claim 30, wherein a materially bonding additional substance is provided as a sealing means, or said sealing means take the form of mechanically interacting sealing edges at the edges of the core elements.

32. The structural component according to claims 28, wherein the core, or at least one of the core elements, is provided with at least one internal stiffening element.

33. The structural component according to claim 28, wherein the internal stiffening element takes the form of a strut or rib.

34. The structural component according to claim 33, wherein struts or ribs of core elements assembled to form a core support one another.

35. The structural component according to claim 26, wherein the core has at least one protruding position element on its circumferential surface, and the position element is provided to fix the core in place inside a mold cavity of a shaping mold for production of the supporting shell element in said mold cavity.

36. The structural component according to claim 25, wherein the supporting shell element forms the shape of a bicycle frame comprising a front end contour with head tube portion, a bottom contour with bottom bracket portion, a top contour with seat tube portion and a back end contour with back end portion for a back wheel axle.

37. A bicycle frame comprising a plurality of frame components, some of which are configured as node elements and some as frame elements, wherein the node elements and frame elements are connected together, wherein at least one of the node elements and/or one of the frame elements is configured as a structural component according to claim 25.

38. The bicycle frame according to claim 37, wherein a material bond is provided to connect the node element to the frame element.

39. The bicycle frame according to claim 38, wherein the material bond is provided using a materially bonding additional material.

40. The bicycle frame according to claim 37, wherein at least one node element is provided with a fusion region, and wherein at least one frame element is provided with a connection region which interacts with the fusion region of the node element.

41. The bicycle frame according to claim 40, wherein the additional bonding material is arranged between the fusion region of the node element and the connection region of the frame element.

42. A bicycle comprising at least one element from the following group including bicycle frame, fork, stem, handlebar, seatpost, crank arms, wherein at least one of the stated elements is configured as a structural component according to claim 25.

43. A Handlebar for a bicycle, configured as a structural component according to claim 25.

44. The handlebar according to claim 43, wherein a core is provided which is assembled from at least two core elements, and wherein the core elements are injection molded from a thermoplastic plastics material.

45. The handlebar according to claim 43, wherein a retaining portion is arranged at each of the free ends of the core elements and provided to fix the core element in place in an injection mold.

46. The handlebar according to claim 45, wherein the retaining portions of the core elements are of complementary configuration, and wherein each core element has a means for positioning it correctly in contact with the complementary core element.

47. The handlebar according to 45, wherein the retaining portions of the core elements, when assembled into a core, form a polygonal cross-section, and wherein the assembled retaining portions have external retaining surfaces.

48. The handlebar according to claim 45, wherein the polygonal cross-section of the core is a hexagonal cross-section.
